(19) United States
(12) Patent Application Publication
(10) Pub. No.: US 2012/0106481 A1
(43) Pub. Date: May 3, 2012

(54) METHOD AND APPARATUS FOR ADJUSTING A PARAMETER OF A TERMINAL IN A WIRELESS COMMUNICATION SYSTEM

(76) Inventors: Hee Jeong Cho, Anyang-si (KR); Ki Seon Ryu, Anyang-si (KR); Young Soo Yuk, Anyang-si (KR); Hyun Woo Lee, Anyang-si (KR)

(21) Appl. No.: 13/322,423

(22) PCT Filed: May 25, 2010
(86) PCT No.: PCT/KR2010/003287

§ 371 Date: Jan. 9, 2012

Related U.S. Application Data
(60) Provisional application No. 61/180,924, filed on May 25, 2009.
(60) Provisional application No. 61/239,015, filed on Sep. 1, 2009.
(60) Provisional application No. 61/240,243, filed on Sep. 7, 2009.
(60) Provisional application No. 61/249,604, filed on Oct. 8, 2009.
(60) Provisional application No. 61/250,873, filed on Oct. 13, 2009.
(60) Provisional application No. 61/253,822, filed on Oct. 21, 2009.
(60) Provisional application No. 61/257,848, filed on Nov. 4, 2009.
(60) Provisional application No. 61/258,216, filed on Nov. 5, 2009.
(60) Provisional application No. 61/287,196, filed on Dec. 17, 2009.
(60) Provisional application No. 61/289,976, filed on Dec. 23, 2009.

(30) Foreign Application Priority Data
May 25, 2010 (KR) 10-2010-0048424

(51) Int. Cl. H04W 72/04; H04W 52/04

(52) U.S. Cl. 370/329; 370/328

(57) ABSTRACT

The present invention relates to a method and apparatus for adjusting a parameter of a terminal in a wireless communication system. The method for adjusting a parameter of a terminal in a wireless communication system, according to one concept of the present invention, is configured such that the base station transmits, to the terminal, a ranging acknowledgement (hereinafter referred to as “RNG-ACK”) message including a first field which indicates whether the RNG-ACK message is transmitted in a broadcast format, and receives, from the terminal, a signal in accordance with the parameter changed in accordance with the RNG-ACK message.

### TECHNICAL FIELD

The present invention relates to a wireless communication system and, more particularly, to a method and apparatus for adjusting a parameter of a terminal in a wireless communication system.

### BACKGROUND ART

Upon reception of a ranging code, uplink data or a MAC message, if a parameter of a terminal, such as timing, power, frequency, etc., needs to be adjusted, a base station transmits a parameter adjustment value corresponding to the parameter to the terminal.

In a conventional technology, the base station includes the parameter adjustment value in a ranging response (hereinafter referred to as “RNG-RSP”) message and transmits the RNG-RSP message including the parameter adjustment value to the terminal. Upon reception of the RNG-RSP message, the terminal adjusts the parameter depending on the parameter adjustment value included in the RNG-RSP message.

The RNG-RSP message may be transmitted to unspecific terminals in a broadcast or multicast format, and transmitted to a specific terminal in a unicast format.

In addition, when a specific condition is satisfied during a communication procedure performed between the base station and the terminal, the base station can request the terminal not to access other base stations or not to access the corresponding base station for a predetermined time. In the conventional technology, the base station requests the terminal not to access other base stations or not to access the corresponding base station for a predetermined time through a RNG-RSP message. Here, the base station may set a ranging status in the RNG-RSP message as ‘abort’, include a ranging abort timer or downlink frequency override in the RNG-RSP message and transmit the RNG-RSP message. The ranging abort timer corresponds to a time in which access of the terminal to the corresponding base station is restricted, and the downlink frequency override denotes a center frequency of a downlink channel at which the terminal needs to attempt ranging in order to access a base station other than the corresponding base station.

FIG. 1 illustrates a network entry procedure of a terminal from the point of view of a base station.

Referring to FIG. 1, in the network entry procedure of the terminal, the base station, which is waiting for a CDMA initial ranging code from the terminal, receives the CDMA initial ranging code. The base station transmits a RNG-RSP message set to a ‘continue’ status to the terminal when the base station needs to re-receive the ranging code, and transmits a RNG-RSP message set to a ‘success’ status to the terminal when it does not need to re-receive the ranging code. Then, the base station waits for a ranging request (hereinafter referred to as “RNG-REQ”).

In addition, in the network entry procedure of the terminal, the base station can transmit a RNG-RSP message set to an ‘abort’ status to the terminal to request the terminal not to access other base stations or not to access the corresponding base station for a predetermined time.

FIG. 2 illustrates a conventional ranging procedure.

Referring to FIG. 2, if timing and power of a terminal need to be adjusted upon reception of a ranging code, a base station sets a status field of a RNG-RSP message to ‘continue’, includes parameter adjustment values (Tx timing offset adjustment, Tx Power offset adjustment, and Tx frequency offset adjustment) corresponding to the parameters, that is, the timing and power of the terminal, in the RNG-RSP message and transmits the RNG-RSP message to the terminal.

Upon reception of the RNG-RSP message, the terminal adjusts the parameters depending on the received parameter adjustment values and re-transmits the ranging code.

Upon successful reception of the ranging code, the base station sets the status field of the RNG-RSP message to ‘success’ and transmits the RNG-RSP message to the terminal. Here, the base station may include the parameter adjustment values (Tx timing offset adjustment, Tx Power offset adjustment, and Tx frequency offset adjustment) in the RNG-RSP message.

In addition, the base station allocates uplink resources for RNG-REQ message transmission to the terminal through a CDMA allocation uplink-MAP information element (CDMA allocation UP-MAP IE).

A conventional CDMA allocation UL-MAP IE is as follows.

| | | Size | |
|---|---|---|---|
| Syntax | | (bit) | Notes |
| CDMA_Allocation_IE( ) { | | — | — |
| | Duration | 6 | — |
| | UIUC | 4 | UIUC for transmission |
| | Repetition Coding | 2 | 0b00: No repetition coding |
| | Indication | | 0b01: Repetition coding of 2 used |
| | | | 0b10: Repetition coding of 4 used |
| | | | 0b11: Repetition coding of 6 used |
| | Frame Number Index | 4 | LSBs of relevant frame number |
| | Ranging Code | 8 | — |
| | Ranging Symbol | 8 | — |
| | Ranging subchannel | 7 | — |
| | BW request mandatory | 1 | 1: Yes |

| | | |
|---|---|---|
| | | 0: No |
| } | — | — |

According to this conventional technology, since the base station informs the terminal of the parameter adjustment values through the RNG-RSP message, the base station needs to notify the terminal of a resource region in which the RNG-RSP message is transmitted through an A-MAP IE, and then transmit the RNG-RSP message to the terminal. This increases signaling overhead.

Furthermore, the base station can transmit a parameter adjustment value even to a terminal that does not transmit a ranging code thereto in order to adjust a parameter of the terminal at any time. In addition, the base station can transmit a parameter adjustment value to unspecific terminals or specific terminals any time. At this time, it is inefficient to transmit a parameter adjustment value only through a message such as a RNG-RSP message including information regarding only one terminal in terms of resources.

Accordingly, it is necessary to design a transmission format for transmitting a parameter adjustment value to a terminal that does not transmit a ranging code.

### DISCLOSURE

### Technical Problem

According to the conventional technology, since the base station informs the terminal of a parameter adjustment value through a RNG-RSP message, signaling overhead is increased. Furthermore, it is required to design a transmission format for transmitting a parameter adjustment value to a terminal that does not transmit a ranging code.

An object of the present invention devised to solve the problem lies in a method for adjusting a parameter of a terminal to reduce overhead.

Another object of the present invention devised to solve the problem lies in a method for adjusting a parameter of a terminal that does not transmit a ranging code.

It will be appreciated by persons skilled in the art that the objects that can be achieved with the present invention are not limited to what has been particularly described hereinabove and the above and other objects that the present invention can achieve will be more clearly understood from the following detailed description.

### Technical Solution

In accordance with one aspect of the present invention to achieve the objects, a method for adjusting a parameter of a terminal in a base station of a wireless communication system includes transmitting a ranging acknowledgement (hereinafter referred to as “RNG-ACK”) message including a first field which indicates whether the RNG-ACK message is transmitted in a broadcast format or in a unicast format to the terminal, and receiving a signal according to the parameter changed depending on the RNG-ACK message.

In accordance with another aspect of the present invention to achieve the objects, a method for adjusting a parameter in a terminal of a wireless communication system includes receiving a ranging acknowledgement (hereinafter referred to as “RNG-ACK”) message including a first field which indicates whether the RNG-ACK message is transmitted in a broadcast format or in a unicast format from a base station, and changing the parameter on the basis of the RNG-ACK message.

The RNG-ACK message may further include a second field which indicates whether the RNG-ACK message includes a timing offset adjustment field, a power level adjustment field, and a frequency offset adjustment field, the timing offset adjustment field indicates the amount of transmission time that needs to be adjusted to allow a signal transmitted from the terminal to be arrived at the base station at an expected time, the power level adjustment field indicates a transmission power level that needs to be adjusted to allow a signal transmitted from the terminal to be arrived at the base station with appropriate power, and the frequency offset adjustment field indicates the amount of a transmission frequency that needs to be adjusted to be synchronized with the base station.

The RNG-ACK message may further include a field which indicates an index of a received code when the first field indicates that the RNG-ACK message is transmitted in a broadcast format.

In accordance with another aspect of the present invention to achieve the objects, a base station includes a transmission module configured to transmit a ranging acknowledgement (hereinafter referred to as “RNG-ACK”) message including a first field which indicates whether the RNG-ACK message is transmitted in a broadcast format or in a unicast format to a terminal, and a receiving module configured to receive a signal according to a parameter changed depending on the RNG-ACK message from the terminal.

In accordance with another aspect of the present invention to achieve the objects, a terminal includes a receiving module configured to receive a ranging acknowledgement (hereinafter referred to as “RNG-ACK”) message including a first field which indicates whether the RNG-ACK message is transmitted in a broadcast format or in a unicast format from a base station, and a processor configured to change a parameter on the basis of the RNG-ACK message.

### Advantages of Invention

According to embodiments the present invention, overhead can be reduced, and even a parameter of a terminal that does not transmit a ranging code can be adjusted.

It will be appreciated by persons skilled in the art that the effects that can be achieved with the present invention are not limited to what has been particularly described hereinabove and other advantages of the present invention will be more clearly understood from the following detailed description.

### DESCRIPTION OF DRAWINGS

FIG. 1 illustrates a network entry procedure of terminal from the point of view of a base station;

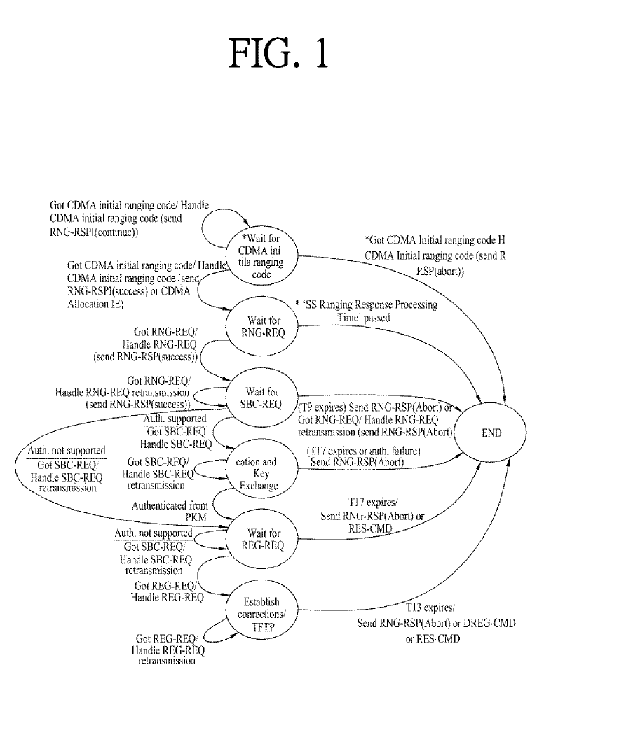

FIG. 2 illustrates a conventional ranging procedure;

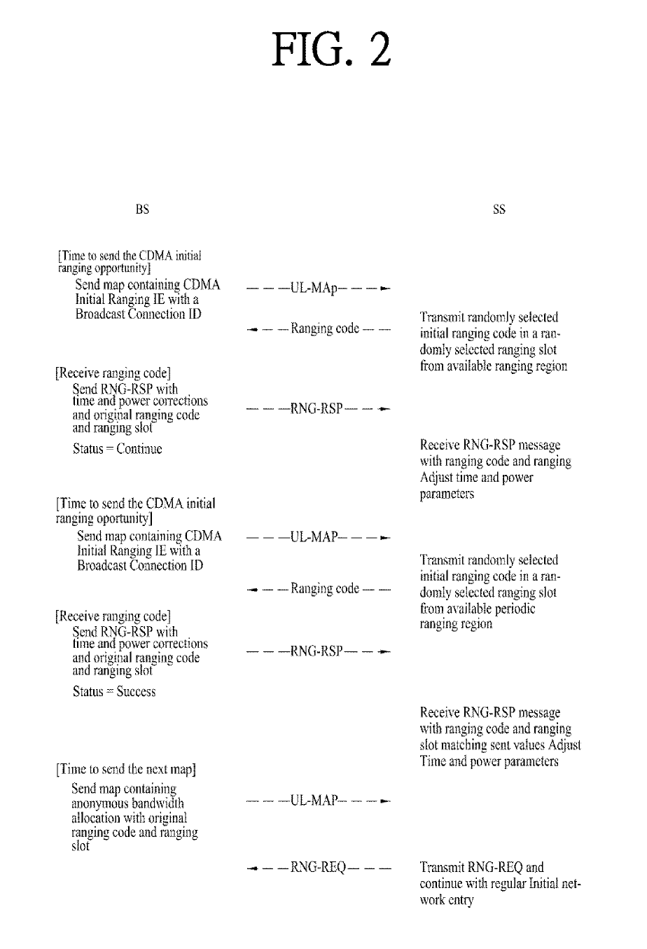

FIG. 3 illustrates a case in which a parameter adjustment value is transmitted through an additional MAC message and a case in which a parameter adjustment value is transmitted through an extended header of a MAC message delivered to a terminal;

FIG. 4 shows a MAC message including a parameter adjustment value and a signaling header including a parameter adjustment value; and

FIG. 5 shows configurations of a mobile terminal and a base station capable of implementing exemplary embodiments of the present invention.

### BEST MODE FOR CARRYING OUT THE INVENTION

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details. For example, while the following description is made on the assumption that a mobile communication system is a 3GPP LTE-A system (or terminal), the present invention can be applied to other arbitrary mobile communication systems except features of the 3GPP LTE-A system (or terminal).

In some instances, known structures and devices are omitted, or are shown in block diagram form focusing on important features of the structures and devices, so as not to obscure the concept of the present invention. The same reference numbers will be used throughout this specification to refer to the same or like parts.

In addition, in the following description, a terminal designates a mobile or fixed user device, such as a UE (User Equipment), MS (Mobile Station), relay node as a downlink receiving subject, etc. A base station designates an arbitrary node on a network, which communicates with terminals, such as a Node B, eNode B, base station, relay node as a downlink receiving subject, etc.

First, a value transmitted from a base station to adjust a parameter of a terminal is explained. Upon reception of a ranging code or data from the terminal, if a parameter of the terminal needs to be adjusted, the base station transmits an adjustment value corresponding to the parameter to the terminal. In an exemplary embodiment of the present invention, the base station adjusts timing, power and frequency of the terminal.

The base station transmits a timing offset adjustment value to adjust the timing of the terminal. The timing offset adjustment value means the amount of transmission time of the terminal, which needs to be adjusted to allow a signal transmitted from the terminal to be arrived at the base station an expected time. The terminal advances the transmission time by the absolute value of the timing offset adjustment value when the timing offset adjustment value is a negative number, and delays the transmission time by the absolute value of the timing offset adjustment value when the timing offset adjustment value is a positive number.

The base station transmits a power offset adjustment value to adjust the power of the terminal. The power offset adjustment value means a transmission power level which needs to be adjusted to allow a signal transmitted from the terminal to be arrived at the base station with appropriate power. The power offset adjustment value corresponds to a power level adjustment value.

The base station transmits a frequency offset adjustment value to adjust the frequency of the terminal. The frequency offset adjustment value means the amount of a transmission frequency which needs to be changed by the terminal to be synchronized with the base station. The terminal increases the transmission frequency when the frequency offset adjustment value is a positive number, and decreases the transmission frequency when the frequency offset adjustment value is a negative number.

A method for adjusting a parameter of a terminal according to a first exemplary embodiment of the present invention will now be explained.

In the first exemplary embodiment of the present invention, a base station transmits a parameter adjustment value to the terminal through an advanced-MAP information element (A-MAP IE).

The A-MAP IE in accordance with the first exemplary embodiment of the present invention may include an A-MAP type field, a timing offset adjustment field, a power offset adjustment value, a frequency offset adjustment value, a status field, a code index field, an opportunity index field, and masked cyclic redundancy check (hereinafter referred to as “MCRC”).

The A-MAP type field represents the type of an A-MAP IE, and the timing offset adjustment field represents a timing offset adjustment value. The power offset adjustment field indicates a power offset adjustment value, and the frequency offset adjustment field denotes a frequency offset adjustment value.

The status field indicates whether the base station has received a ranging code successfully or whether the base station instructs the terminal not to access other base stations or not to access the corresponding base station for a predetermined time. That is, the status field represents that the base station instructs the terminal to re-transmit a ranging code when it is set to ‘continue’, and indicates that the base station has successfully received the ranging code when it is set to ‘success’. In addition, the status field represents that the base station instructs the terminal not to access other base stations or not to access the corresponding base station for a predetermined time when it is set to ‘abort’.

The code index field represents a code received by the base station, and the opportunity field represents a transmission opportunity at which the base station receives a code.

The MCRC may be CRC masked using STID allocated for ranging response purpose, or CRC masked using RAID generated depending on random access characteristic.

When CRC is masked using the RAID, the A-MAP IE does not need to include the random access characteristic, and thus the A-MAP IE may not include the code index field and the opportunity index field.

Tables 1 and 2 show exemplary A-MAP IEs in accordance with the first exemplary embodiment of the present invention when the CRC is masked by STID.

TABLE 1

| | Bit size | |
|---|---|---|
| Fields | (Example) | note |
| A-MAP IE( ) { | | |
| A-MAP Type | 4 | |
| Opportunity index | 2 (TBD) | |
| Code index | 6 | |
| Status (continue, abort, success) | 2 | |
| If (Status == continue ∥ success) { | | |
| Timing Adjust | 18 (TBD) | |
| Power Level Adjust | 5 (TBD) | |
| Offset Frequency Adjust } | 5 (TBD) | |
| If (Status == abort) { | | |
| Preamble index/DL frequency } | TBD | new DL channel |
| | | where the SS |
| | | should redo initial |
| | | ranging. |
| MCRC } | 16 | Masked by STID |

TABLE 2

| | Bit size | |
|---|---|---|
| Fields | (Example) | note |
| A-MAP IE( ) { | | |
| A-MAP Type | 4 | |
| Code index | 6 | |
| Status (continue, abort, success) | 2 | |
| If (Status == continue \|\| success) { | | |
| Timing Adjust | 18 (TBD) | |
| Power Level Adjust | 5 (TBD) | |
| Offset Frequency Adjust } | 5 (TBD) | |
| If (Status == abort) { | | |
| Preamble index/DL frequency } | TBD | new DL channel |
| | | where the SS |
| | | should redo |
| | | initial ranging. |
| MCRC } | 16 | Masked by STID |

Table 2 shows an A-MAP IE when a relative position to which the A-MAP IE is transmitted depending on the location of a transmission opportunity at which a code is transmitted, or when only one transmission opportunity is present in a previous frame. Accordingly, the A-MAP IE shown in Table 2 does not include an opportunity index field.

As shown in Tables 1 and 2, the A-MAP IE in accordance with the first exemplary embodiment of the present invention includes the timing offset adjustment field, power offset adjustment field, and frequency offset adjustment field when its status corresponds to ‘continue’ or ‘success’, and includes a preamble index/DL frequency field when its status corresponds to ‘abort’. The preamble index/DL frequency represents a new downlink channel for which the terminal needs to re-attempt initial ranging.

Tables 3 and 4 show exemplary A-MAP IEs in accordance with the first exemplary embodiment of the present invention when the CRC is masked by RAID.

TABLE 3

| | Bit size | |
|---|---|---|
| Fields | (Example) | note |
| A-MAP IE( ) { | | |
| A-MAP Type | 4 | |
| Status (continue, abort, success) | 2 | |
| If (Status == continue \|\| success) { | | |
| Timing Adjust | 18 (TBD) | |
| Power Level Adjust | 5 (TBD) | |
| Offset Frequency Adjust } | 5 (TBD) | |
| If (Status == abort) { | | |
| Preamble index/DL frequency } | TBD | new DL channel |
| | | where the SS should |
| | | redo initial ranging. |
| MCRC } | 16 | Masked by RAID |

TABLE 4

| | Bit size | |
|---|---|---|
| Fields | (Example) | note |
| A-MAP IE( ) { | | |
| A-MAP Type | 4 | Random access |
| Extended A-MAP Type | 2 | |
| If (Extended A-MAP | | |
| Type == ranging ACK) { | | |
| Status (continue, abort, success) | 2 | |
| If (Status == continue \|\| success) { | | |
| Timing Adjust | 18 (TBD) | |
| Power Level Adjust | 5 (TBD) | |
| Offset Frequency Adjust }} | 5 (TBD) | |
| If (Status == abort) { | | |
| Preamble index/DL frequency } | TBD | new DL channel |
| | | where the SS |
| | | should redo initial |
| | | ranging. |
| MCRC } | 16 | Masked by RAID |

An extended A-MAP type field indicates the type of the corresponding A-MAP IE among A-MAP IEs associated with random access. For example, the extended A-MAP IE can indicate whether the A-MAP IE corresponds to ranging acknowledgement (ranging ACK) or a CDMA allocation A-MAP IE.

When the A-MAP IE includes only a field associated with parameter adjustment, the base station may not transmit the A-MAP IE for a code index in ‘success’ status.

Next, a case in which the base station transmits a parameter adjustment value to the terminal using a CDMA allocation A-MAP IE.

If a parameter adjustment value can be represented within a representation range of a corresponding parameter bit size in the CDMA allocation A-MAP IE, the base station includes the parameter adjustment value in the CDMA allocation A-MAP IE and transmits the CDMA allocation A-MAP IE including the parameter adjustment value to the terminal. For example, if the frequency offset adjustment field has 9 bits, the representation range corresponds to a range of −255 Hz to 255 Hz. Accordingly, if a frequency adjustment value to be adjusted by the base station belongs to the range of −255 Hz to 255 Hz, the base station can transmit the frequency offset adjustment value through the CDMA allocation A-MAP IE.

Furthermore, the base station can allocate an uplink resource while transmitting the parameter adjustment value to the terminal through the CDMA allocation A-MAP IE. Upon reception of the CDMA allocation A-MAP IE, the terminal adjusts a corresponding parameter depending on the parameter adjustment value, and then transmits a ranging request (hereinafter referred to as “RNG-REQ”) message through the allocated uplink resource.

If the parameter adjustment value cannot be represented within the representation range of the corresponding parameter bit sizes in the CDMA allocation A-MAP IE, the base station sets a corresponding parameter adjustment field of the CDMA allocation A-MAP IE to 0, and transmits the parameter adjustment value through a RNG-RSP or RNG-ACK message.

When the base station does not need to transmit a parameter adjustment value to the terminal, the base station sets a corresponding parameter adjustment field of the CDMA allocation A-MAP IE to 0.

Table 5 shows an exemplary CDMA allocation A-MAP IE in accordance with the first exemplary embodiment of the present invention.

TABLE 5

| Fields | Bit size (Example) |
|---|---|
| CDMA Allocation A-MAP IE( ) { | |
| A-MAP Type | 4 |
| if MCRC is masked with RAID and | |
| masking indicator for BR { | |
| Resource Index | 11 |
| Long TTI Indicator | 1 |
| I_{sizeoffset} | 0~5 |
| HFA | 3 |
| Power Level Adjust | 4 |
| } | |
| Else if MCRC is masked with RAID and | |
| masking indicator for Ranging { | |
| Resource Index | 11 |
| Long TTI Indicator | 1 |
| I_{sizeoffset} | 5 |
| HFA | 3 |
| ACID | 0~3 |
| Allocation relevance | 0~2 |
| Timing Adjust | ~9 |
| Power Level Adjust | ~3 |
| Offset Frequency Adjust | ~4 |
| } | |
| MCRC | |
| } | 16 |

As shown in Table 5, the CDMA allocation A-MAP IE does not include a field for parameter adjustment when a resource for bandwidth request is allocated.

Ranging includes synchronous ranging and asynchronous ranging. Periodic ranging corresponds to the synchronous ranging, and initial ranging and handover ranging correspond to the asynchronous ranging.

In the case of periodic ranging, since the terminal does not need to transmit a RNG-REQ message, the base station that has received a ranging code transmits only a parameter adjustment value without allocating an uplink resource. Accordingly, the CDMA allocation A-MAP IE includes only parameter adjustment related fields without having resource allocation related fields in the case of periodic ranging.

Therefore, the current exemplary embodiment of the present invention proposes an allocation type field to determine whether the CDMA allocation A-MAP IE is related to asynchronous ranging, synchronous ranging or bandwidth request.

Table 6 shows an exemplary CDMA allocation A-MAP IE including the allocation type field in accordance with the first exemplar embodiment of the present invention.

TABLE 6

| Syntax | Size (bits) | Notes |
|---|---|---|
| CDMA_Allocation_A-MAP IE( ) { | | — |
| A-MAP IE Type | 4 | |
| Allocation Type | 2 | 0b00: unsynchronized ranging, 0b01: synchronized ranging, |
| | | 0b10: BWREQ, 0b11: resved |
| If Allocation Type=10{ | | |
| Resource assignment Information | TBD | Information for Resource Index and Long TTI Indicator |
| HFA | 4 | HARQ Feedback Allocation [If ABS assigns HFA implicitly, |
| | | this parameter is unnecessary.] |
| Power Level Adjust | 4 | Relative change in transmission power level. Signed in units of 1 dB |
| Reserved | TBD | |
| } | | |
| Else if Allocation Type=01 { | | |
| Status (continue, abort, success) | 2 | |
| Timing Adjust | 18 | Included when status is continue or success. |
| Power Level Adjust | 5 | Included when status is continue or success. |
| Offset Frequency Adjust | 5 | Included when status is continue or success. |
| Reserved | TBD | |
| } | | |
| Else if Allocation Type=00 { | | |
| Resource assignment Information | TBD | Information for Resource Index, Long TTI Indicator and I_{sizeoffset} |
| HFA | 4 | HARQ Feedback Allocation. If needs, ACID should be also included. |
| Timing Adjust | 10 | Amount of advance time required to adjust AMS transmission. |
| | | Unsigned in units of 1/Fs |
| Power Level Adjust | 4 | Relative change in transmission power level. Signed in units of 1 dB |
| Offset Frequency Adjust | 6 | Relative change in transmission frequency. Signed in units of Hz |
| Reserved | TBD | |
| } | | |
| MCRC | 16 | CRC masked by 12-bit RA-ID |
| } | | |

As shown in Table 6, the allocation type field indicates that the CDMA allocation A-MAP IE is related to asynchronous ranging when it is 0b00, represents that the CDMA allocation A-MAP IE is associated with synchronous ranging when it is 0b01, and indicates that the CDMA allocation A-MAP IE is related to bandwidth request when it is 0b10.

Accordingly, the CDMA allocation A-MAP IE includes only resource allocation related fields without having parameter adjustment associated fields when the allocation type field is 0b10. The CDMA allocation A-MAP IE includes only the parameter adjustment related fields without having the resource allocation related fields when the allocation type field is 0b01. The CDMA allocation A-MAP IE includes both the parameter adjustment related fields and the resource allocation related fields when the allocation type field is 0b00.

Table 7 shows an exemplary CDMA allocation A-MAP IE including the allocation type field and a type field in accordance with the first exemplary embodiment of the present invention.

TABLE 7

| Syntax | Size (bits) | Notes |
|---|---|---|
| CDMA_Allocation_A-MAP IE( ) { | | — |
| A-MAP IE Type | 4 | |
| Allocation Type | 2 | 0: unsynchronized ranging |
| | | 1: synchronized ranging/BWREQ |
| If Allocation Type=1{ | | |
| Type | 1 | 0: BWREQ |
| | | 1: synchronized ranging |
| If Type=0{ | | |
| Resource assignment Information | TBD | Information for Resource Index and Long TTI Indicator |
| HFA | 4 | HARQ Feedback Allocation [If ABS assigns HFA implicitly, |
| | | this parameter is unnecessary.] |
| Power Level Adjust | 4 | Relative change in transmission power level. Signed in units of 1 dB |
| Reserved | TBD | |
| } | | |
| Else if Type=1 { | | |
| Status (continue, abort, success) | 2 | |
| Timing Adjust | 18 | Included when status is continue or success. |
| Power Level Adjust | 5 | Included when status is continue or success. |
| Offset Frequency Adjust | 5 | Included when status is continue or success. |
| Reserved | TBD | |
| } | | |
| Else if Allocation Type=0 { | | |
| Resource assignment Information | TBD | Information for Resource Index, Long TTI Indicator and I_{sizeoffset} |
| HFA | 4 | HARQ Feedback Allocation. If needs, ACID should be also included. |
| Timing Adjust | 10 | Amount of advance time required to adjust AMS transmission. |
| | | Unsigned in units of 1/Fs |
| Power Level Adjust | 4 | Relative change in transmission power level. Signed in units of 1 dB |
| Offset Frequency Adjust | 6 | Relative change in transmission frequency. Signed in units of Hz |
| Reserved | TBD | |
| } | | |
| MCRC | 16 | CRC masked by 12-bit RA-ID |
| } | | |

As shown in FIG. 7, the allocation type field indicates that the CDMA allocation A-MAP IE is related to asynchronous ranging when it is 0, and represents that the CDMA allocation A-MAP IE is associated with synchronous ranging or bandwidth allocation when it is 1.

In addition, when the allocation type field is 1, the CDMA allocation A-MAP IE includes the type field. The type field indicates that the CDMA allocation A-MAP IE is related to bandwidth request when it is 0 and represents that the CDMA allocation A-MAP IE is associated with synchronous ranging when it is 1.

When the base station transmits only a parameter adjustment value, the base station can transmit the parameter adjustment value through a CDMA allocation A-MAP IE, and thus the base station may not transmit a RNG-RSP message. In this case, the base station sets a resource index field to 0, and the terminal can recognize that a RNG-RSP is not transmitted when the resource index field is 0. If the base station transmits only a parameter adjustment value only for periodic ranging, the terminal can recognize that a RNG-RSP message is not transmitted when a ranging type field indicates periodic ranging.

Tables 8, 9 and 10 show examples in accordance with the first exemplary embodiment of the present invention.

TABLE 8

| Fields | Bit size (Example) |
|---|---|
| CDMA Allocation A-MAP IE( ) { | |
| A-MAP Type | 4 |
| if MCRC is masked with RAID and | |
| masking indicator for BR { | |
| Resource Index | 11 |
| Long TTI Indicator | 1 |
| I_{sizeoffset} | 0~5 |
| HFA | 3 |
| Power Level Adjust } | 4 |
| Else if MCRC is masked with RAID and | |
| masking indicator for Ranging { | |
| Resource Index | 11 |
| if (Resource Index != 0) { | |
| Long TTI Indicator | 1 |
| I_{sizeoffset} | 5 |
| HFA | 3 |
| ACID | 0~3 |
| Allocation relevance | 0~2 |
| Timing Adjust | ~8 |
| Power Level Adjust | ~4 |
| Offset Frequency Adjust } | ~4 |
| if (Resource Index == 0) { | |
| Status | |
| Timing Adjust | 9 |
| Power Level Adjust | 5 |
| Offset Frequency Adjust }} | 5 |
| MCRC | 16 |
| } | |

TABLE 9

| Fields | Bit size (Example) |
|---|---|
| CDMA Allocation A-MAP IE( ) { | |
| A-MAP Type | 4 |
| if MCRC is masked with RAID and | |
| masking indicator for BR { | |
| Resource Index | 11 |
| Long TTI Indicator | 1 |
| HFA | 3 |
| Power Level Adjust } | 4 |
| Else if MCRC is masked with RAID and | |
| masking indicator for Ranging { | |
| UL indicator | 1 |
| if(UL indicator == 0) { | For DL |
| Ranging type } | 1 |
| if(UL indicator == 1 \|\| Ranging type == 0) { | UL or Initial/HO ranging |
| Resource Index | 11 |
| Long TTI Indicator | 1 |
| I_{sizeoffset} | 5 |
| HFA | 3 |
| ACID | 0~3 |
| Allocation relevance | 0~2 |
| Timing Adjust | ~8 |
| Power Level Adjust | ~4 |
| Offset Frequency Adjust } | ~4 |
| if ((Ranging type == 1) { | Periodic ranging |
| Timing Adjust | 9 |
| Power Level Adjust | 5 |
| Offset Frequency Adjust }} | 5 |
| MCRC | 16 |
| } | |

TABLE 10

| Syntax | Size (bits) | Notes |
|---|---|---|
| CDMA_Allocation_A-MAP IE( ) { | | — |
| A-MAP IE type | 4 | CDMA Allocation A-MAP IE |
| If MCRC is masked with RAID and | | |
| masking indicator for BR { | | |
| Resource Index | 11 | 5 MHz: 0 in first 2 MSB bits + 9 bits for resource index |
| | | 10 MHz: 11 bits for resource index |
| | | 20 MHz: 11 bits for resource index |
| | | Resource index includes location and allocation size. |
| Long TTI Indicator | 1 | Indicates number of AAI subframes spanned by the allocated resource. |
| | | 0b0: 1 AAI subfrarne (default) |
| | | 0b1: 4 UL AAI subframes for FDD or all UL AAI subframes for TDD |
| | | If number of DL AAI subframes, D, is less than number of UL AAI subframes, |
| | | U, Long TTI Indicator = 0b1 |
| HFA | 3 | HARQ Feedback Allocation |
| Power Level Adjust | 4 | Relative change in transmission power level. Signed in units of 1 dB |
| } | | |
| Else if MCRC is masked with RAID and | | |
| masking indicator for Ranging { | | |
| Uplink/Downlink Indicator | 1 | Indicates whether the following fields are for resource |
| | | assignment in the uplink or in the downlink. |
| | | 0b0: Uplink 0b1: Downlink |
| Resource Index | 11 | 5 MHz: 0 in first 2 MSB bits + 9 bits for resource index |
| | | 10 MHz: 11 bits for resource index |
| | | 20 MHz: 11 bits for resource index |
| | | Resource index includes location and allocation size. |
| Long TTI Indicator | 1 | Indicates number of AAI subframes spanned by the allocated resource. |
| | | 0b0: 1 AAI subframe (default) |
| | | 0b1: 4 UL AAI subframes for FDD or all UL AAI subframes for TDD |
| | | If number of DL AAI subframes, D, is less than number of UL AAI subframes, |
| | | U, Long TTI Indicator = 0b1 |
| I_{SizeOffset} | 5 | Offset used to compute burst size index |
| HFA | 3 | HARQ Feedback Allocation |
| Timing Adjust | 8 | Amount of advance time required to adjust AMS transmission. |
| | | Signed in units of 1/Fs. |
| Power Level Adjust | 3 | Relative change in transmission power level. Signed in units of 1 dB |
| Offset Frequency Adjust | 4 | Relative change in transmission frequency. Signed in units of Hz |
| } | | |
| Padding | variable | Padding to reach byte boundary |
| MCRC | 16 | CRC masked by RA-ID and Masking Indicator |
| } | | — |

In the case of contention-based random access initial ranging or handover ranging, the base station transmits a parameter adjustment value to the terminal through a CDMA allocation A-MAP IE when the parameter adjustment value can be represented through a corresponding field in the CDMA allocation A-MAP IE, and transmits the parameter adjustment value to the terminal through a RNG-RSP message when the parameter adjustment value cannot be represented through the corresponding field.

In the case of non-contention-based random access initial ranging or handover ranging, when the base station transmits a RNG-REQ message or RNG-RSP message allocation information through a CDMA allocation A-MAP IE, the base station transmits a parameter adjustment value to the terminal through the CDMA allocation A-MAP IE when the parameter adjustment value can be represented through a corresponding field in the CDMA allocation A-MAP IE and transmits the parameter adjustment value to the terminal through a RNG-RSP message when the parameter adjustment value cannot be represented through the corresponding field.

When the base station transmits a RNG-REQ message or RNG-RSP message allocation information through a unicast A-MAP IE, the base station transmits a parameter adjustment value to the terminal through a RNG-RSP message.

Next, a method for adjusting a parameter of a terminal in accordance with a second exemplary embodiment of the present invention will be explained.

The second exemplary embodiment of the present invention describes a method for adjusting a parameter of a terminal when a base station does not receive a ranging code. That is, the base station may determine that a parameter of the terminal needs to be adjusted even when receiving uplink data or a MAC message from the terminal.

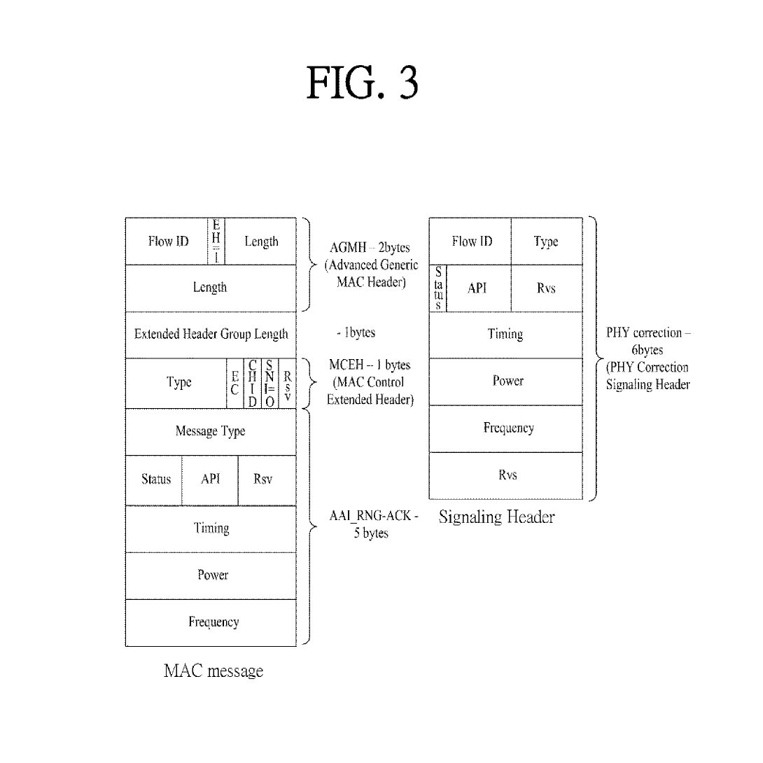

A case in which the base station transmits a parameter adjustment value through a signaling header is explained with reference to FIG. 3. When there is no data to be transmitted to the terminal, the base station can transmit parameter adjustment and abort associated information through the signaling header.

FIG. 3 shows a MAC message including a parameter adjustment value and a signaling header including a parameter adjustment value.

Table 11 shows resource units (RUs) required when a parameter adjustment value is transmitted through a MAC message and when a parameter adjustment value is transmitted through a signaling header.

TABLE 11

| | MAC PDU | | | | | | | | |
|---|---|---|---|---|---|---|---|---|---|
| | | | | | | Using Signaling Header | | | |
| | Using AAI_RNG-ACK | | | | | (Proposal) | | | |
| | | AAI_RNG- | | Total | | | | Total | |
| I_{sizeoffset} | Header | ACK | CRC | length | RU# | Header | CRC | length | RU# |
| 0 | 4 | 5 | 2 | 11 | 6 | 6 | 2 | 8 | 4 |
| 1 | 4 | 5 | 2 | 11 | 5 | 6 | 2 | 8 | 1~3 |

As shown in FIG. 3 and Table 11, when the parameter adjustment value is transmitted through the signaling header, approximately 2 RUs can be saved as compared to the case where the parameter adjustment value is transmitted through the MAC message.

Tables 12 and 13 show exemplary signaling headers in accordance with the second exemplary embodiment of the present invention.

TABLE 12

| | |
|---|---|
| Flow ID | FID for Signaling header |
| Signaling Header type | |
| Sub-type | 0b0: PHY adjustment |
| | 0b1: Reinitialize MAC |
| If Sub-type == 0b0{ | |
| Tx timing offset adjustment | The amount of time required to adjust |
| | SS transmission so the bursts will arrive |
| | at the expected time instance at the BS. |
| Tx Power offset adjustment | Specifies the relative change in |
| | transmission power level that the SS is |
| | to make in order that transmissions |
| | arrive at the BS at the desired power. |
| Tx frequency offset adjustment } | Specifies the relative change in |
| | transmission frequency that the SS is |
| | to make in order to better match the BS. |
| If Sub-type == 0b1{ | |
| Ranging Abort Timer | Timer is defined by a BS to prohibit the |
| | MS from attempting network entry at |
| | this BS, for a specific time duration. |
| DL Frequency override } | Center frequency, in kHz, of new DL |
| | channel where the SS should redo |
| | ranging. |

TABLE 13

| | Size | |
|---|---|---|
| Syntax | (bit) | Notes |
| PHY Corrections | | |
| header( ) { | | |
| FID | 4 | Flow Identifier. This field indicates MAC |
| | | signaling header |
| Type | 4 | MAC signaling header type = 0b0100 |
| Status | 1 | 0b0: success, 0b1: continue |
| Timing offset | 11 | Amount of advance time required to adjust |
| adjustment | | AMS transmission. Signed in units of 1/Fs. |
| Power level | 3 | Relative change in transmission |
| adjustment | | power level. |
| | | Signed in units of 1 dB |
| Frequency offset | 7 | Relative change in transmission frequency. |
| adjustment | | The correction is 0.1% of the |
| | | subcarrier spacing (Δf) |
| | | multiplied by the 7-bit number |
| | | interpreted as a signed integer. |
| Padding | variable | |
| } | | |

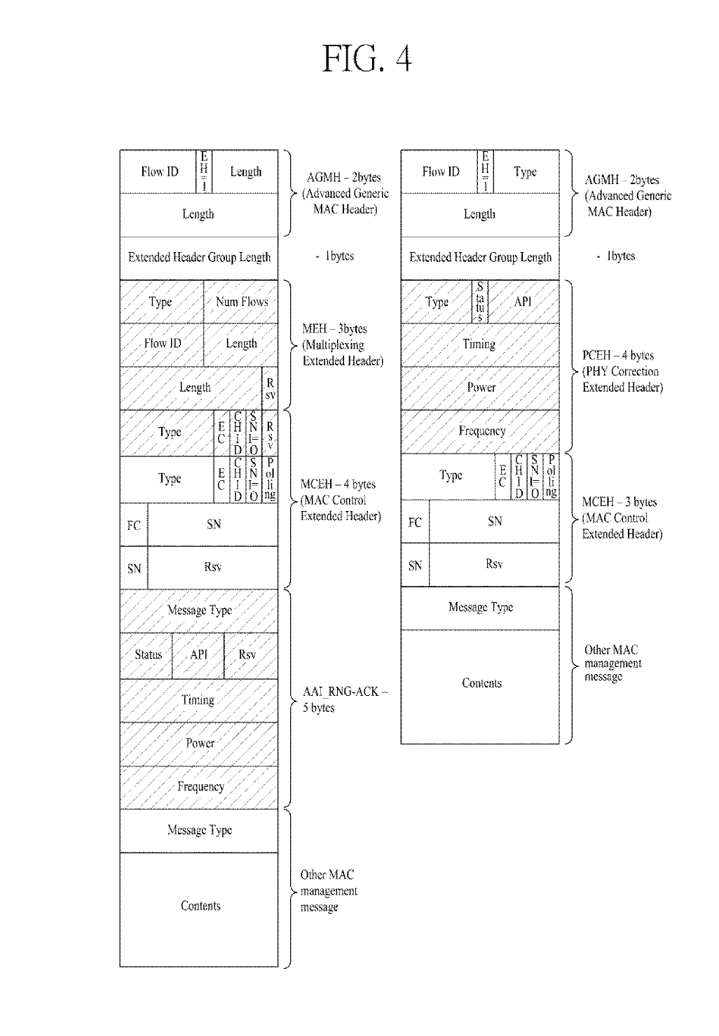

Next, a case in which the base station transmits a parameter adjustment value through an extended header will be explained with reference to FIG. 4. When there is data to be transmitted to the terminal, the base station can transmit the parameter adjustment and abort related information through the extended header.

FIG. 4 shows a case in which a parameter adjustment value is transmitted through an additional MAC message and a case in which a parameter adjustment value is transmitted through an extended header of a MAC message delivered to the terminal.

Table 14 shows a RU required when a parameter adjustment value is transmitted through an additional MAC message and when a parameter adjustment value is transmitted through an extended header of a MAC message transmitted to the terminal.

TABLE 14

| | | | | | | | Using Extended Header (Proposal) | | | | |
|---|---|---|---|---|---|---|---|---|---|---|---|
| MAC PDU | | AAI_RNG- | Other | | Total | | | Other | | Total | |
| I_{sizeoffset} | Header | ACK | message | CRC | length | RU# | Header | message | CRC | length | RU# |

| | Using AAI_RNG-ACK - Multiplexing | | | | | | | | | | |
|---|---|---|---|---|---|---|---|---|---|---|---|
| 0 | 10 | 5 | 10 | 2 | 27 | 13 | 10 | 10 | 2 | 22 | 10 or 11 |
| 1 | 10 | 5 | 10 | 2 | 27 | 12 | 10 | 10 | 2 | 22 | 9 |
| 2 | 10 | 5 | 10 | 2 | 27 | 10 or | 10 | 10 | 2 | 22 | 8 |
| | | | | | | 11 | | | | | |
| | Using AAI_RNG-ACK - Concatenating | | | | | | | | | | |
| 0 | 10 | 5 | 10 | 4 | 29 | 14 or | 10 | 10 | 2 | 22 | 10 or 11 |
| | | | | | | 15 | | | | | |
| 1 | 10 | 5 | 10 | 4 | 29 | 13 | 10 | 10 | 2 | 22 | 9 |
| 2 | 10 | 5 | 10 | 4 | 29 | 12 | 10 | 10 | 2 | 22 | 8 |

Tables 15 and 16 show exemplary extended headers in accordance with the second exemplary embodiment of the present invention.

TABLE 15

| | |
|---|---|
| Extended header Group Length | |
| Extended Header type | |
| Sub-type | 0b0: PHY adjustment |
| | 0b1: Reinitialize MAC |
| If Sub-type == 0b0{ | |
| Tx timing offset adjustment | The amount of time required to adjust |
| | SS transmission so the bursts will arrive |
| | at the expected time instance at the BS. |
| Tx Power offset adjustment | Specifies the relative change in |
| | transmission power level that the SS is |
| | to make in order that transmissions |
| | arrive at the BS at the desired power. |
| Tx frequency offset adjustment} | Specifies the relative change in |
| | transmission frequency that the SS is to |
| | make in order to better match the BS. |
| If Sub-type == 0b1{ | |
| Ranging Abort Timer | Timer is defined by a BS to prohibit the |
| | MS from attempting network entry at |
| | this BS for a specific time duration. |
| DL Frequency override } | Center frequency, in kHz, of new DL |
| | channel where the SS should redo |
| | ranging. |

TABLE 16

| | Size | |
|---|---|---|
| Syntax | (bit) | Notes |
| PCEH ( ) { | | |
| Type | 4 | Extended header type = 0b1001 |
| Status | 1 | 0b0: success, 0b1: continue |
| Adjustment parameters | 3 | Bit#0: Time offset adjustment |
| indi-cation (API) | | indication. |
| | | Bit#1: Power level adjustment |
| | | indication |
| | | Bit#2: Frequency offset |
| | | adjustment indi-cation |
| If (API bit #0 == 1) { | | |
| Timing offset adjustment } | 11 | Amount of advance time required |
| | | to adjust AMS transmission. |
| | | Signed in units of 1/Fs. |
| If (API bit #1 == 1) { | | |
| Power level adjustment } | 3 | Relative change in transmission |
| | | power level. |
| | | Signed in units of 1 dB |
| If (API bit #2 == 1) { | | |
| Frequency offset | 7 | Relative change in transmission |
| adjustment } | | frequency. |
| | | The correction is 0.1% of the |
| | | subcarrier spacing (Δf) multiplied |
| | | by the 7-bit number interpreted |
| | | as a signed integer. |
| Padding | variable | |
| } | | |

A case in which the base station transmits a parameter adjustment value through a ranging acknowledgement (hereinafter referred to as “RNG-ACK”) message will now be explained.

Table 17 shows an exemplary RNG-ACK message in accordance with the second exemplary embodiment of the present invention.

TABLE 17

| Syntax | Notes |
|---|---|
| RNG-ACK_Message_Format( ) { | — |
| Management Message Type=TBD | — |
| Purpose | This field indicates whether the AAI_RNG-ACK |
| | is sent in response to the CDMA ranging |
| | request or it is sent asynchronously. |
| | 0b0: AAI_RNG-ACK is sent in response to the |
| | CDMA ranging request; |
| | 0b1: AAI_RNG-ACK is sent asynchronously. |
| If Purpose == 0b0 { | |
| RNG-ACK Bitmap | Each bit indicates the decoding status of |
| | ranging code in the corresponding ranging |
| | opportunity. 0b0: No ranging code is detected, |
| | 0b1: At least one code is detected. |
| For (i=0; i<N_RNG_Slots; i++) { | — |
| If (RNG-ACK Bitmap[i] == 1) { | — |
| Number of Received codes (L) | The number of ranging code indices included in |
| | this RNG-ACK message. |
| For (j=0; j<L; j++) { | — |
| Code index | Code index received in the ranging opportunity |
| Ranging status | Used to indicate whether UL messages are |
| | received within acceptable limits by BS. 0b01 = |
| | continue, 0b11 = abort, 0b00 = success |
| If (Ranging status == 0b01 \|\| 0b00) { | — |
| API | Adjustment parameters indication Bit#0: “1” |
| | Timing Offset Adjustment is included; Bit#1: |
| | “1” Power Level Adjustment is included; Bit#2: |
| | “1” Frequency Offset Adjustment is included; |
| If( API bit#0==1){ | |
| Timing Offset Adjustment } | Tx timing offset adjustment |
| If (API bit#1==1){ | |
| Power Level Adjustment} | Tx Power offset adjustment |
| If (API bit#2==1) { | |
| Frequency Offset Adjustment } } | Tx frequency offset adjustment |
| If (Ranging status == 0b11) { | |
| RPI | Re-initialization parameters indication Bit#0: “1” |
| | ranging abort timer is included; Bit#1: “1” DL |
| | frequency override is included; |
| If( RPI bit#0==1){ | |
| Ranging Abort Timer } | Timer is defined by a BS to prohibit the MS |
| | from attempting network entry at this BS, for a |
| | specific time duration. |
| If( RPI bit#1==1){ | |
| DL Frequency override} | Center frequency, in kHz, of new DL channel |
| | where the SS should redo ranging. |
| } } }}} | |
| If Purpose == 0b1 { | |
| status | Used to indicate whether UL messages are |
| | received within acceptable limits by BS. 0b1 = |
| | abort, 0b0 = success |
| If (status == 0b0) { | — |
| API | Adjustment parameters indication Bit#0: “1” |
| | Timing Offset Adjustment is included; Bit#1: |
| | “1” Power Level Adjustment is included; Bit#2: |
| | “1” Frequency Offset Adjustment is included; |
| If( API bit#0==1){ | |
| Timing Offset Adjustment } | Tx timing offset adjustment |
| If (API bit#1==1){ | |
| Power Level Adjustment} | Tx Power offset adjustment |
| If (API bit#2==1) { | |
| Frequency Offset Adjustment } } | Tx frequency offset adjustment |
| If (Ranging status == 0b1) { | |
| RPI | Re-initialization parameters indication Bit#0: “1” |
| | ranging abort timer is included; Bit#1: “1” DL |
| | frequency override is included; |
| If( RPI bit#0==1){ | |
| Ranging Abort Timer } | Timer is defined by a BS to prohibit the MS |
| | from attempting network entry at this BS, for a |
| | specific time duration. |
| If( RPI bit#1==1){ | |
| DL Frequency override}}} | Center frequency, in kHz, of new DL channel |
| | where the SS should redo ranging. |

As shown in Table 17, the RNG-ACK message in accordance with the second exemplary embodiment of the present invention includes a purpose field.

The purpose field indicates whether the RNG-ACK message is transmitted as a response to a received ranging code or transmitted when the base station does not receive the ranging code. When the base station transmits the RNG-ACK message as a response to the ranging code, the base station transmits the RNG-ACK message in a broadcast format since the base station is not aware of a terminal which transmits the ranging code. When the base station determines that a parameter of a specific terminal needs to be adjusted through data or a MAC message received from the specific terminal without receiving a ranging code and transmits a parameter adjustment value to the terminal through a RNG-ACK message, the base station transmits the RNG-ACK message in a unicast format.

Accordingly, the purpose field indicates whether a RNG-ACK message is transmitted in a broadcast format or in a unicast format.

The RNG-ACK message is transmitted as a response to a received ranging code when the purpose field is 0b0, and the RNG-ACK message is transmitted when the base station does not receive a ranging code when the purpose field is 0b1.

As shown in Table 17, when the purpose field is 0b0, the RNG-ACK message includes a ranging acknowledgement (RNG-ACK) bitmap field, a field regarding the number of received codes, a code index field, and a ranging status field.

The RNG-ACK bitmap field indicates whether a ranging code is sensed for each ranging opportunity, the field regarding the number of received codes represents the number of code indexes included in the RNG-ACK message, and the code index field represents a code index received at a corresponding ranging opportunity.

The ranging status field indicates whether the base station has successfully received a ranging code or whether the base station instructs the terminal not to access other base station or not to access the corresponding base station for a predetermined time. That is, the ranging status field represents that the base station instructs the terminal to re-transmit the ranging code thereto when it is 0b01, represents that the base station has successfully received the ranging code when it is 0b00, and represents that the base station instructs the terminal not to access other base station or not to access the corresponding base station for a predetermined time when it is 0b11.

The RNG-ACK message includes an API field when the ranging status field is 0b01 or 0b00.

The API field indicates whether each field for parameter adjustment is included in a RNG-ACK message. That is, the API field represents whether each of the timing offset adjustment field, power level adjustment field, and frequency offset adjustment field is included in the RNG-ACK message.

When the purpose field is 0b0, the RNG-ACK message may include the timing offset adjustment field, power level adjustment field, and frequency offset adjustment field depending on the value of the API field value.

As shown in Table 17, the RNG-ACK message includes a status field when the purpose field is 0b1.

The status field indicates whether the base station has received an uplink message within an allowable restriction. The status field indicates that the base station has successfully received the uplink message when it is 0b0, and represents that the base station instructs the terminal not to access other base station or not to access the corresponding base station for a predetermined time when it is 0b1.

The RNG-ACK message may include the API field when the status field is 0b0, and may include the timing offset adjustment field, power level adjustment field, and frequency offset adjustment field depending on the value of the API field value.

That is, the RNG-ACK message does not include the RNG-ACK bitmap field, the field regarding the number of received codes, and the code index field.

Table 18 shows an exemplary RNG-ACK message in accordance with the second exemplary embodiment of the present invention.

TABLE 18

| Syntax | Notes |
|---|---|
| RNG-ACK_Message_Format( ) { | — |
| Management Message Type=TBD | — |
| If CRC is masked by | |
| Broadcast/multicast STID { | |
| RNG-ACK Bitmap | Each bit indicates the decoding status of ranging |
| | code in the corresponding ranging opportunity. |
| | 0b0: No ranging code is detected, 0b1: At least |
| | one code is detected. |
| For (i=0; i<N_RNG_Slots; i++) { | — |
| If (RNG-ACK Bitmap[i] == 1) { | — |
| Number of Received codes (L) | The number of ranging code indices included in |
| | this RNG-ACK message. |
| For (j=0; j<L; j++) { | — |
| Code index | Code index received in the ranging opportunity |
| Ranging status | Used to indicate whether UL messages are |
| | received within acceptable limits by BS. 0b01 = |
| | continue, 0b11 = abort, 0b00 = success |
| If (Ranging status == 0b01 \|\| 0b00) { | — |
| API | Adjustment parameters indication Bit#0: “1” |
| | Timing Offset Adjustment is included; Bit#1: “1” |
| | Power Level Adjustment is included; Bit#2: “1” |
| | Frequency Offset Adjustment is included; |
| If( API bit#0==1){ | |
| Timing Offset Adjustment } | Tx timing offset adjustment |
| If (API bit#1==1){ | |
| Power Level Adjustment} | Tx Power offset adjustment |
| If (API bit#2==1) { | |
| Frequency Offset Adjustment } } | Tx frequency offset adjustment |
| If (Ranging status == 0b11) { | |
| RPI | Re-initialization parameters indication Bit#0: “1” |
| | ranging abort timer is included; Bit#1: “1” DL |
| | frequency override is included; |
| If( RPI bit#0==1){ | |
| Ranging Abort Timer } | Timer is defined by a BS to prohibit the MS from |
| | attempting network entry at this BS, for a specific |
| | time duration. |
| If( RPI bit#1==1){ | |
| DL Frequency override} | Center frequency, in kHz, of new DL channel |
| | where the SS should redo ranging. |
| } } }}} | |
| If CRC is masked by unicast STID { | |
| status | Used to indicate whether UL messages are |
| | received within acceptable limits by BS. 0b1 = |
| | abort, 0b0 = success |
| If (status == 0b00) { | — |
| API | Adjustment parameters indication Bit#0: “1” |
| | Timing Offset Adjustment is included; Bit#1: “1” |
| | Power Level Adjustment is included; Bit#2: “1” |
| | Frequency Offset Adjustment is included; |
| If( API bit#0==1){ | |
| Timing Offset Adjustment } | Tx timing offset adjustment |
| If (API bit#1==1){ | |
| Power Level Adjustment} | Tx Power offset adjustment |
| If (API bit#2==1) { | |
| Frequency Offset Adjustment } } | Tx frequency offset adjustment |
| If (Ranging status == 0b1) { | |
| RPI | Re-initialization parameters indication Bit#0: “1” |
| | ranging abort timer is included; Bit#1: “1” DL |
| | frequency override is included; |
| If( RPI bit#0==1){ | |
| Ranging Abort Timer } | Timer is defined by a BS to prohibit the MS from |
| | attempting network entry at this BS, for a specific |
| | time duration. |
| If( RPI bit#1==1){ | |
| DL Frequency override}}} | Center frequency, in kHz, of new DL channel |
| | where the SS should redo ranging. |

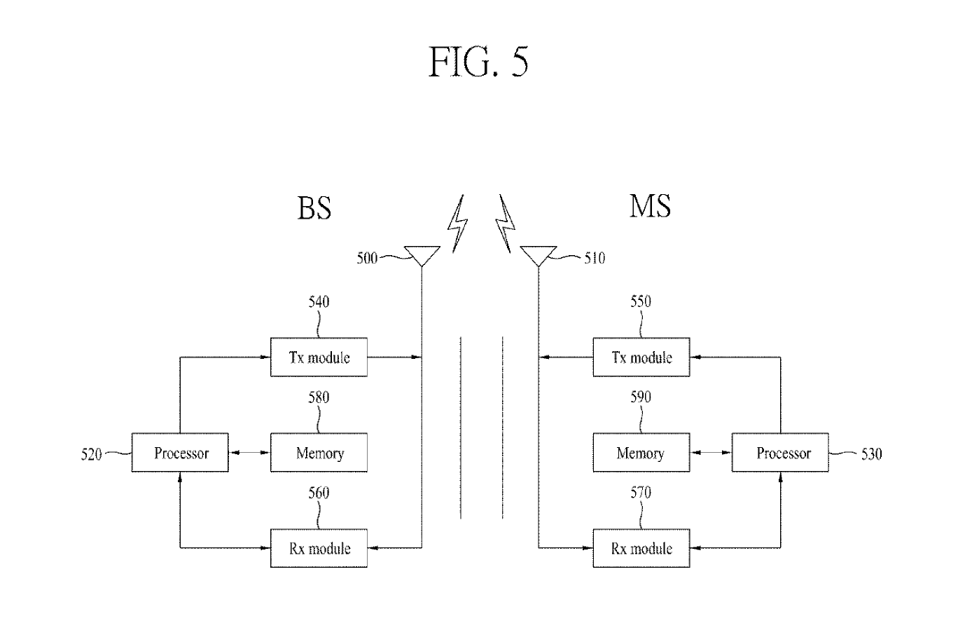

FIG. 5 shows configurations of a mobile terminal and a base station capable of implementing the above-described exemplary embodiments of the present invention.

A base station ABS and a mobile terminal AMS respectively include antennas 500 and 510 for transmitting and receiving information, data, signals and/or messages, transmission modules (Tx modules) 540 and 550 for controlling the antennas to transmit messages, receiving modules (Rx modules) 560 and 570 for controlling the antennas to receive messages, memories 580 and 590 for storing information related to communications with the base station, and processors 520 and 530 for controlling the receiving modules and the memories. Here, the base station may be a femto base station or a macro base station.

The antennas 500 and 510 transmit signals generated in the transmission modules 540 and 550 to the outside, or receive radio signals and transmit the radio signals to the receiving modules 560 and 570. Two or more antennas can be included when a MIMO (Multi-Input Multi-Output) function is supported.

The processors 520 and 530 control overall operations of the base station and the mobile terminal. Particularly, the processors can perform a control function, a function of controlling MAC (Medium Access Control) frame variation depending on service characteristics and propagation environment, a handover function, authentication and coding functions, etc. for performing the aforementioned exemplary embodiments of the present invention. Furthermore, the processors 520 and 530 may further include encryption modules for controlling encryption of various messages and timer modules for controlling transmission and reception of various messages.

In addition, the processor 520 of the base station generates a RNG-ACK message including a first field that indicates whether a RNG-ACK message is transmitted in a broadcast format or in a unicast format, and the processor 530 of the mobile terminal 530 changes a parameter depending on the RNG-ACK message received from the base station.

The transmission modules 540 and 550 may perform predetermined coding and modulation on signals and/or data to be scheduled and transmitted to the outside, and transmit the coded and modulated signals and/or data to the antennas 500 and 510.

The transmission module 540 of the base station transmits a RNG-ACK message to the mobile terminal, and the transmission module 550 of the mobile terminal transmits a signal depending on a parameter changed on the basis of the RNG-ACK message received from the base station.

The receiving modules 560 and 570 may perform decoding and demodulation on radio signals received through the antennas 500 and 510 to restore the signals into signals in the form of original data and transmit the signals to the processors 520 and 530.

The receiving module 570 of the mobile terminal receives the RNG-ACK message including the first field that indicates whether the RNG-ACK message is transmitted in a broadcast format or in a unicast format from the base station.

The memories 580 and 590 may store programs for processing and control of the processors, temporarily store input/output data (uplink grant, system information, station identifier (STID), flow identifier (FID), action time, region allocation information, frame offset information, etc. in case of a mobile station).

Furthermore, the memories may include a storage medium of at least one of a flash memory type, hard-disc type, multimedia card micro type, card type memory (for example, SD or XD memory), RAM (Random Access Memory, SRAM (Static Random Access Memory), ROM (Read Only memory, EEPROM (Electrically Erasable Random Access Memory), PROM (Programmable Read-Only Memory), magnetic memory, magnetic disc, and optical disc.

Those skilled in the art will appreciate that the present invention may be embodied in other specific forms than those set forth herein without departing from the spirit and essential characteristics of the present invention. The above description is therefore to be construed in all aspects as illustrative and not restrictive.

The scope of the invention should be determined by reasonable interpretation of the appended claims and all changes coming within the equivalency range of the invention are intended to be within the scope of the invention.

1. A method for adjusting a parameter of a terminal in a base station of a wireless communication system, the method comprising:
transmitting a ranging acknowledgement (hereinafter referred to as “RNG-ACK”) message including a first field which indicates whether the RNG-ACK message is transmitted in a broadcast format or in a unicast format to the terminal; and
receiving a signal according to the parameter changed depending on the RNG-ACK message.

2. The method according to claim 1, wherein the RNG-ACK message further includes a second field which indicates whether the RNG-ACK message includes a timing offset adjustment field, a power level adjustment field, and a frequency offset adjustment field,
wherein the timing offset adjustment field indicates the amount of transmission time that needs to be adjusted to allow a signal transmitted from the terminal to be arrived at the base station at an expected time, the power level adjustment field indicates a transmission power level that needs to be adjusted to allow a signal transmitted from the terminal to be arrived at the base station with appropriate power, and the frequency offset adjustment field indicates the amount of a transmission frequency that needs to be adjusted to be synchronized with the base station.

3. The method according to claim 1, wherein the RNG-ACK message further includes a field which indicates an index of a received code when the first field indicates that the RNG-ACK message is transmitted in a broadcast format.

4. The method according to claim 1, further comprising receiving a ranging code from the terminal,
wherein the first field indicates that the RNG-ACK message is transmitted in a broadcast format.

5. A method for adjusting a parameter in a terminal of a wireless communication system, the method comprising:
receiving a ranging acknowledgement (hereinafter referred to as “RNG-ACK”) message including a first field which indicates whether the RNG-ACK message is transmitted in a broadcast format or in a unicast format from a base station; and
changing the parameter on the basis of the RNG-ACK message.

6. The method according to claim 5, wherein the RNG-ACK message further includes a second field which indicates whether the RNG-ACK message includes a timing offset adjustment field, a power level adjustment field, and a frequency offset adjustment field,
wherein the timing offset adjustment field indicates the amount of transmission time that needs to be adjusted to allow a signal transmitted from the terminal to be arrived at the base station at an expected time, the power level adjustment field indicates a transmission power level that needs to be adjusted to allow a signal transmitted from the terminal to be arrived at the base station with appropriate power, and the frequency offset adjustment field indicates the amount of a transmission frequency that needs to be adjusted to be synchronized with the base station.

7. The method according to claim 5, wherein the RNG-ACK message further includes a field which indicates an index of a received code when the first field indicates that the RNG-ACK message is transmitted in a broadcast format.

8. The method according to claim 5, further comprising transmitting a ranging code to the base station,
wherein the first field indicates that the RNG-ACK message is transmitted in a broadcast format.

9. A base station comprising:
a transmission module configured to transmit a ranging acknowledgement (hereinafter referred to as “RNG-ACK”) message including a first field which indicates whether the RNG-ACK message is transmitted in a broadcast format or in a unicast format to a terminal; and
a receiving module configured to receive a signal according to a parameter changed depending on the RNG-ACK message from the terminal.

10. The base station according to claim 9, wherein the RNG-ACK message further includes a second field which indicates whether the RNG-ACK message includes a timing offset adjustment field, a power level adjustment field, and a frequency offset adjustment field,
wherein the timing offset adjustment field indicates the amount of transmission time that needs to be adjusted to allow a signal transmitted from the terminal to be arrived at the base station at an expected time, the power level adjustment field indicates a transmission power level that needs to be adjusted to allow a signal transmitted from the terminal to be arrived at the base station with appropriate power, and the frequency offset adjustment field indicates the amount of a transmission frequency that needs to be adjusted to be synchronized with the base station.

11. The base station according to claim 9, wherein the RNG-ACK message further includes a field which indicates an index of a received code when the first field indicates that the RNG-ACK message is transmitted in a broadcast format.

12. The base station according to claim 9, wherein the first field indicates that the RNG-ACK message is transmitted in a broadcast format when the transmission module receives a ranging code from the terminal.

13. A terminal comprising:
a receiving module configured to receive a ranging acknowledgement (hereinafter referred to as “RNG-ACK”) message including a first field which indicates whether the RNG-ACK message is transmitted in a broadcast format or in a unicast format from a base station; and
a processor configured to change a parameter on the basis of the RNG-ACK message.

14. The terminal according to claim 13, wherein the RNG-ACK message further includes a second field which indicates whether the RNG-ACK message includes a timing offset adjustment field, a power level adjustment field, and a frequency offset adjustment field,
wherein the timing offset adjustment field indicates the amount of transmission time that needs to be adjusted to allow a signal transmitted from the terminal to be arrived at the base station at an expected time, the power level adjustment field indicates a transmission power level that needs to be adjusted to allow a signal transmitted from the terminal to be arrived at the base station with appropriate power, and the frequency offset adjustment field indicates the amount of a transmission frequency that needs to be adjusted to be synchronized with the base station.

15. The terminal according to claim 13, wherein the RNG-ACK message further includes a field which indicates an index of a received code when the first field indicates that the RNG-ACK message is transmitted in a broadcast format.

16. The terminal according to claim 13, further comprising a transmission module configured to transmit a ranging code to the base station,
wherein the first field indicates that the RNG-ACK message is transmitted in a broadcast format.
